(19) United States
(12) Patent Application Publication
(10) Pub. No.: US 2026/0166765 A1
(43) Pub. Date: Jun. 18, 2026

(54) BOLT CUTTER

(71) Applicant: Milwaukee Electric Tool Corporation, Brookfield, WI (US)

(72) Inventors: Milorad Marich, Mequon, WI (US); Jonathan G. Winter, Burlington, WI (US); Zachary Bernaden, Milwaukee, WI (US); Bryson Wilcox, Kenosha, WI (US); Jackson Trent Baker, Monument, CO (US); Garrett Andrew Howard, Indian Hills, CO (US); Grant Christopher Minnihan, Sycamore, IL (US); Sergio Lopez, Denver, CO (US)

(21) Appl. No.: 19/531,064

(22) Filed: Feb. 5, 2026

Related U.S. Application Data
(62) Division of application No. 18/139,451, filed on Apr. 26, 2023.
(60) Provisional application No. 63/335,415, filed on Apr. 27, 2022.

(51) Int. Cl. B26B 17/02; B25G 1/04

(52) U.S. Cl. CPC B26B 17/02; B25G 1/04

(57) ABSTRACT

A bolt cutter comprising a bolt cutting head and a pair of handles. The bolt cutting head includes a pair of blades and a pair of links. Each link is coupled to one of the pair of blades. Each of the handles defines a longitudinal axis and includes a handle portion and a grip sleeve portion. The handle portion is coupled to one of the pair of links, and the handle portion has an outer surface with a tip projecting therefrom. The grip sleeve portion surrounds the handle portion and is movable along the handle axis of the corresponding handle between a retracted position and an extended position to adjust a length of the corresponding handle. The grip sleeve portion includes an inner surface having a slot provided thereon. The slot selectively receives the tip to adjust the length.

### CROSS-REFERENCE TO RELATED APPLICATION

This application is a divisional application of co-pending U.S. patent application Ser. No. 18/139,451, filed Apr. 26, 2023, which claims priority to U.S. Provisional Patent Application 63/335,415, filed Apr. 27, 2022, the entire contents of all of which are incorporated herein by reference.

### FIELD OF THE DISCLOSURE

The present disclosure relates to bolt cutters, and more particularly to bolt cutters with adjustable length handles.

### SUMMARY OF THE DISCLOSURE

In one aspect, the disclosure provides a bolt cutter including a bolt cutting head and a pair of handles. The bolt cutting head includes a pair of blades and a pair of links, each link being coupled to one of the pair of blades. Each of the handles defines a longitudinal axis and includes a handle portion and a grip sleeve portion. The handle portion is coupled to one of the pair of links, and has an outer surface with a tip projecting therefrom. The grip sleeve portion surrounds the handle portion and is movable along the handle axis of the corresponding handle between a retracted position and an extended position to adjust a length of the corresponding handle. The grip sleeve portion includes an inner surface having a slot provided thereon, the slot selectively receiving the tip to adjust the length.

In another independent aspect, the disclosure provides a bolt cutter including a first blade, a second blade, first link, a second link, and a plate. The first blade has a first tapered aperture. The second blade has a second tapered aperture. The first link is pivotably coupled to the first blade. The second link is pivotably coupled to the first link and pivotably coupled to the second blade. The plate has a first planar portion, a second planar portion spaced from the first planar portion by a gap, a first tapered post traversing the gap, and a second tapered post traversing the gap. The first tapered aperture receives the first tapered post and the second tapered post receives the second tapered post such that the first blade and the second blade are movable between an open position and a closed position while inhibiting misalignment of the first blade and the second blade.

In another independent aspect, the disclosure provides a bolt cutter including a one-piece first blade; a one-piece second blade, a one-piece first link intertwined with the first blade, a one-piece second link intertwined with the second blade and the first link, a one-piece first blade, a one-piece second blade, and a one-piece plate. The second link is intertwined with the first link. The first blade is intertwined with the first link. The second blade is intertwined with the second link. The plate has a first post intertwined with the first blade and a second post intertwined with the second blade.

Other features and aspects of the invention will become apparent by consideration of the detailed description and accompanying drawings.

### BRIEF DESCRIPTION OF THE DRAWINGS

FIG. 1 is a perspective view of a bolt cutter in accordance with an embodiment of the invention, the bolt cutter being in a closed position.

FIG. 2 is a partial perspective view of the bolt cutter of FIG. 1 in an open position.

FIG. 3 is a top view of the bolt cutter of FIG. 1 with a handle thereof in a retracted position.

FIG. 4 is a top view of the bolt cutter of FIG. 1 with the handle thereof in an extended position.

FIG. 5A is a cross-sectional view of the handle of the bolt cutter of FIG. 1 in a retracted and locked position.

FIG. 5B is a cross-sectional view of the handle of the bolt cutter of FIG. 1 in a retracted and unlocked position.

FIG. 5C is a cross-sectional view of the handle of the bolt cutter of FIG. 1 in an extended and unlocked position.

FIG. 5D is a cross-sectional view of the handle of the bolt cutter of FIG. 1 in an extended and locked position.

FIG. 6A is a cross-sectional view of the handle of the bolt cutter taken along section line 6A-6A in FIG. 5A in the locked position.

FIG. 6B is a cross-sectional view of the handle of the bolt cutter taken along section line 6B-6B in FIG. 5B in the unlocked position.

FIG. 7 is a perspective view of a first link of the bolt cutter of FIG. 1.

FIG. 8 is a perspective view of a second link of the bolt cutter of FIG. 1.

FIG. 9 is a perspective view of a plate of the bolt cutter of FIG. 1.

FIG. 10 is a top view of a cutter head of the bolt cutter of FIG. 1.

FIG. 11 is a cross-sectional view of the cutter head of the bolt cutter taken along section line 11-11 in FIG. 10.

FIG. 12 is an alternate embodiment of a handle for use with the bolt cutter of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

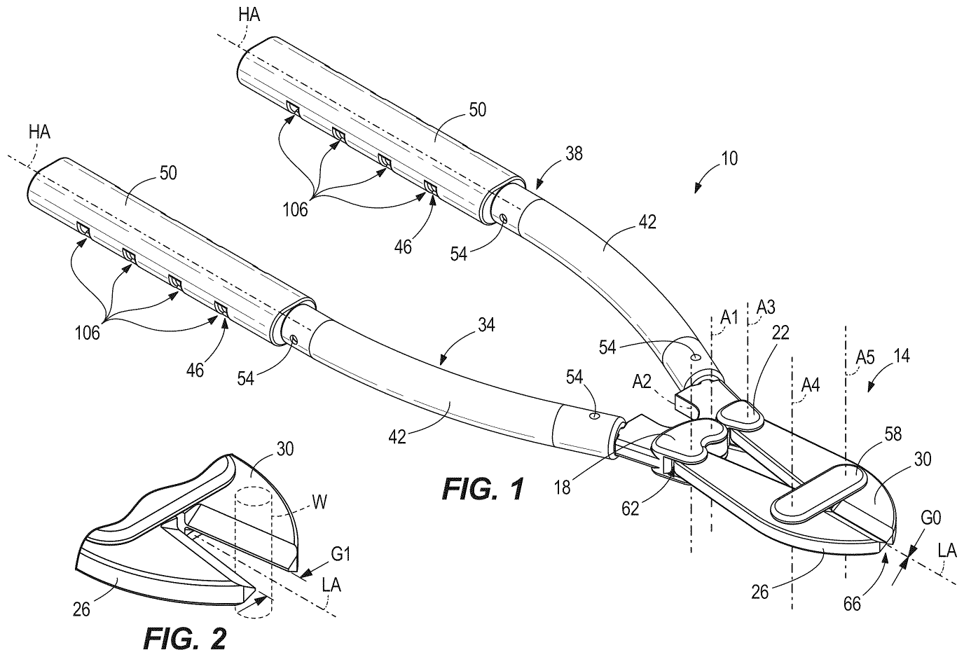

FIG. 1 illustrates a bolt cutter 10. The bolt cutter 10 is configured to provide mechanical advantage for a user to cut a workpiece W. Exemplary workpieces W may include, but are not limited to, padlocks, hardened or unhardened chains, rebar cut wire, bolts, chain link fences, and wire. In some embodiments, exemplary workpieces may have a hardness of up to 48 HRC. In other embodiments, exemplary workpieces may have higher hardnesses.

The bolt cutter 10 includes a bolt cutting head 14 (i.e., a bolt cutter head 14) including a pair of links 18, 22 (i.e., a first link 18, and a second link 22). Each of the links 18, 22 is coupled to a corresponding blade 26, 30 (i.e., a first blade 26, and a second blade 30) and a corresponding handle 34, 38. Each handle 34, 38 has an arm 42, a handle portion 46, and a grip sleeve portion 50. The arms 42 are coupled to the links 18, 22. The handle portions 46 are coupled to the arms 42 opposite the links 18, 22. The grip sleeve portions 50 surround the handle portions 46. The handle portions 46 and the grip sleeve portions 50 are each generally aligned along a handle axis HA of each handle 34, 38. The handle axis HA is a longitudinal axis of each handle 34, 38. In the illustrated embodiment, the handle portions 46 are generally cylindrical about the handle axis HA, and the grip sleeve portions 50 are generally annular about the handle axis HA. More specifically, the grip sleeve portions 50 are both non-circular and annular. As will be described in detail below, each grip sleeve portion 50 is movably coupled to the corresponding handle portion 46. Fastener receptacles 54 are provided on the arms 42 and the handle portions 46 to receive fasteners and secure the arms 42 to the links 18, 22, and the handle portions 46 to the arms 42.

The cutting head 14 further includes a plate 58 which interconnects the blades 26, 30. The plate 58 thus also interconnects the links 18, 22 to one another. Each component (e.g., the links 18, 22, blades 26, 30, and plate 58) of the cutting head 14 is not removable relative to the other components thereof. Accordingly, the cutting head 14 is an intertwined cutting head 14. Each blade 26, 30 has a base portion 62 which is pivotable relative to the corresponding link 18, 22 and a cutting portion 66 which is sharpened and configured to cut the workpiece.

In FIG. 1, the bolt cutter 10 is in a closed position. This is demonstrated by the blades 26, 30 being positioned against each other on an opposite end of the plate 58 when compared to the links 18, 22. A zero-clearance gap G0 exists in this position. This zero-clearance gap G0 may not literally have zero-clearance, but may be operable to fully cut the workpiece W. The zero-clearance gap G0 extends generally along a longitudinal axis LA of the bolt cutter 10. As illustrated in FIG. 1, when the bolt cutter 10 is in the closed position, the handles 34, 38 are relatively close to each other, and the longitudinal axis LA is generally parallel to the handle axis HA of each handle 34, 38.

In FIG. 2, the blades 26, 30 are illustrated in an open position. To transition the bolt cutter 10 to this position, a user may actuate the handles 34, 38 in a direction away from each other and thus away from the longitudinal axis LA. Each handle 34, 38 may be pivotable via the links 18, 22 and about a pivot axis A1. The pivot axis A1 is common to each of the links 18, 22. Structure of each link 18, 22 will be described in detail below. The link 18 (i.e., a first link) is pivotably coupled to the blade 26 (i.e., a first blade) about a first link axis A2. Similarly, the link 22 (i.e., a second link) is pivotably coupled to the blade 30 (i.e., a second blade) about a second link axis A3. The link axes A2, A3 are generally parallel with the pivot axis A1. The blade 26 is pivotably coupled to the plate 58 about a first plate axis A4. Similarly, the blade 30 is pivotably coupled to the plate 58 about a second plate axis A5. Each of the plate axes A4, A5 are generally parallel with the pivot axis A1. During actuation of the handles 34, 38, the base portion 62 and the cutting portion 66 of each blade 26, 30 is pivoted about the corresponding plate axes A4, A5, with the plate axes A4, A5 acting as a fulcrum, and the base portion 62 acting as a lever. As the bolt cutter 10 is moved from the closed position (FIG. 1) to the open position (FIG. 1), each link 18, 22 is pivoted about the pivot axis A1 such that the link axes A2, A3 and thus the base portions 62 are positioned closer to the longitudinal axis LA when compared to the closed position. The cutting portion 66 of each blade 26, 30, being positioned on the opposite side of the plate 58, are thus positioned further away from the longitudinal axis LA when compared to the closed position. This reveals a gap G1 between the cutting portion 66 of each blade 26, 30. The gap G1 is non-zero such that a workpiece to be cut may be received between the blades 26, 30. The gap G1 may be operable to receive up to 5/16″ workpieces therein. The bolt cutter 10 may be otherwise dimensioned to have a larger or smaller gap G1.

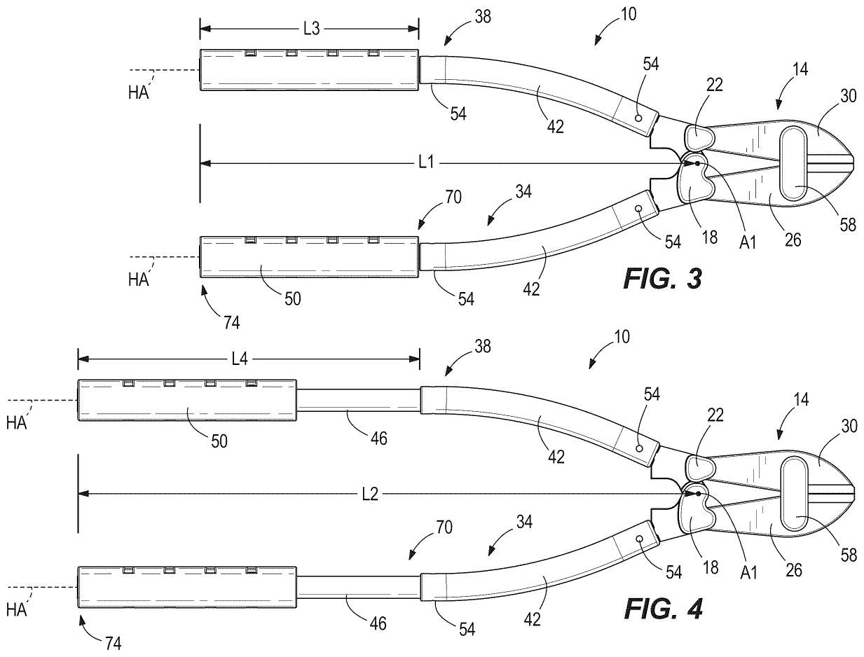

FIGS. 3 and 4 illustrate a transition of the bolt cutter 10 between a retracted position in which each grip sleeve portion 50 is seated upon the handle portion 46 and an extended position in which at least a portion of the grip sleeve portion 50 projects from the handle portion 46. As illustrated, the grip sleeve portion 50 is telescopically translatable along the handle axis HA between the retracted position (FIG. 3) and the extended position (FIG. 4). In the illustrated embodiment, each grip sleeve portion 50 is movable independent of the grip sleeve portion 50 of the opposite handle 34, 38. Each handle 34, 38 has a proximal end 70 closest to the pivot axis A1 and a distal end 74 furthest away from the pivot axis A1. The proximal end 70 is provided by the handle portions 46 and is adjacent the arms 42. The distal end 74 is provided by the grip sleeve portion 50 and is positioned opposite the proximal end 70.

A length L1 of the bolt cutter 10 between the pivot axis A1 and the distal end 74 of the handles 34, 38 in the retracted position (FIG. 3) is less than a length L2 of the bolt cutter 10 in the extended position (FIG. 4). A length L3 of the handles 34, 38 between the proximal end 70 and the distal end 74 in the retracted position (FIG. 3) is less than a length L4 of the handles 34, 38 between the proximal end 70 and the distal end 74 in the extended position (FIG. 4).

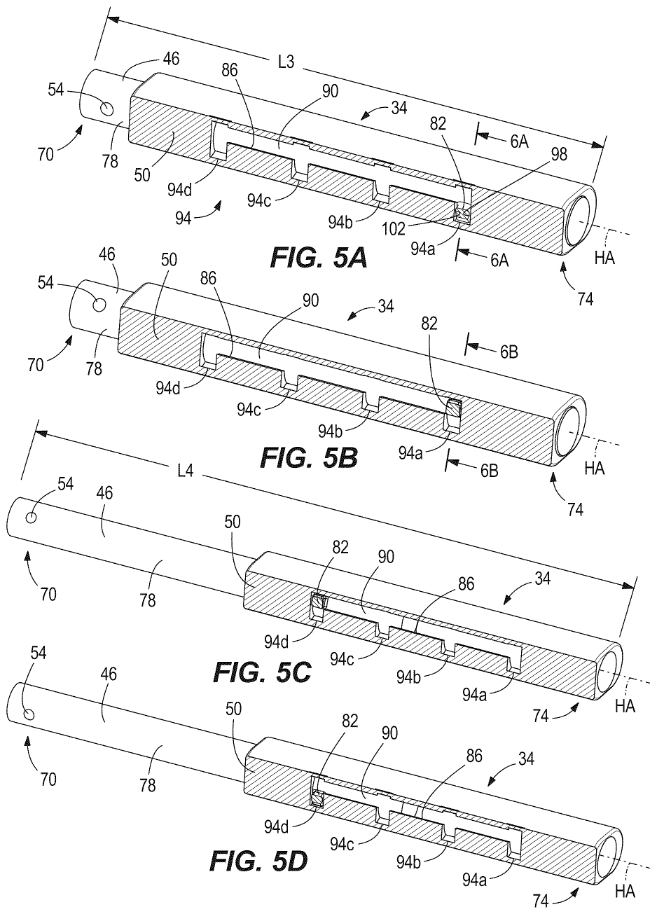

FIGS. 5A-5D illustrate a transition process of one of the handles 34 between the retracted position (FIG. 3) and the extended position (FIG. 4). FIG. 5A shows the handle portion 46 and the grip sleeve portion 50 of the handle 34. A similar transition process may be carried out simultaneously or at another time by the handle 38. The handle portion 46 has an outer surface 78 with a tip 82 projecting therefrom. The grip sleeve portion 50 has an inner surface 86 with a slot 90 provided thereon. The slot 90 extends along the handle axis HA. The slot 90 includes a plurality of notches 94 in communication with the slot 90. In the illustrated embodiment, the plurality of notches 94 includes four notches 94a-94d. In other embodiments, the slot 90 may include fewer or more notches. The illustrated notches 94a-94d are generally equally spaced relative to each other. In some embodiments, the notches 94a-94d may be unevenly spaced. Each notch 94 includes a first end surface 98 and a second end surface 102. The grip sleeve portion 50 is slidably (i.e., telescopically) movable (i.e., translatable) along the handle axis HA, with the tip 82 in the slot 90. The grip sleeve portion 50 is movable along the handle axis HA relative to the handle portion 46 between the retracted position (e.g., FIG. 5A) and an extended position (FIG. 5D). In other embodiments, the tip 82 may be positioned on grip sleeve portion 50, and the slot 90 and notches 94a-94d to be positioned on the handle portion 46.

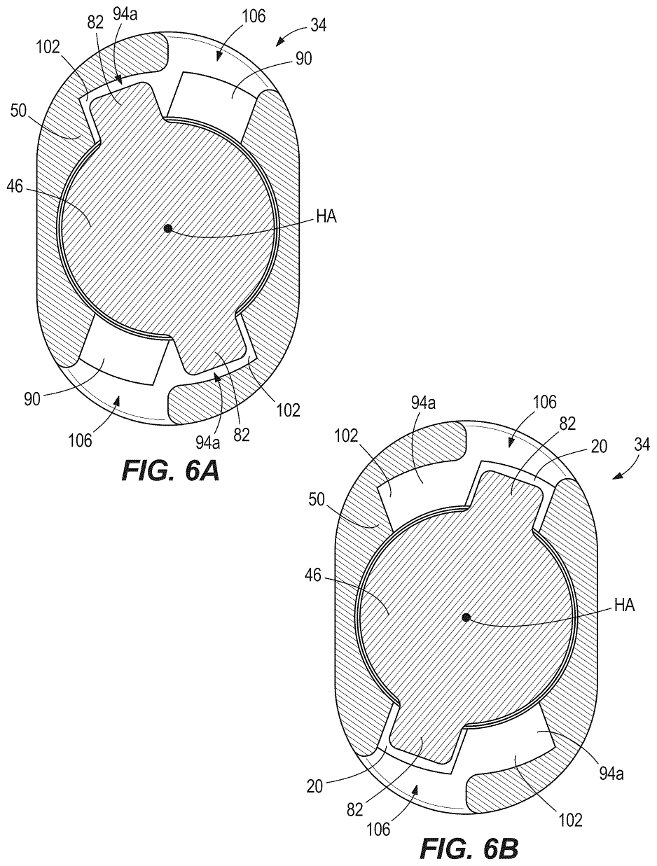

The grip sleeve portion 50 is also movable between a locked position (e.g., FIGS. 5A, 6A) and an unlocked position (e.g., FIGS. 5B, 6B). In transitioning the grip sleeve potion 50 from the locked position to the unlocked position, the grip sleeve portion 50 is rotated about the handle axis HA relative to the handle portion 46. In the locked position of the grip sleeve portion 50, the tip 82 is received within one of the notches 94. As shown in FIG. 5A, the tip 82 is received within the notch 94a and between the end surfaces 98, 102 of the notch 94a. In this position, the tip 82 is configured to abut the end surfaces 98, 102, and the grip sleeve portion 50 is inhibited from translation along the handle axis HA relative to the handle portion 46.

In the unlocked position (FIGS. 5B, 6B), the tip 82 is displaced from the notches 94, and is positioned within the slot 90. The grip sleeve portion 50 is thus configured to be movable relative to the handle portion 46 and along the handle axis HA. The grip sleeve portion 50 is movable such that the tip 82 can be aligned along the handle axis HA adjacent a desired notch 94a-94d to adjust the length L3-L4 the handles 34, 38 and thus the length L1-L2 of the bolt cutter 10 as a whole.

As shown in FIGS. 6A and 6B, the handle portion 46 has two tips 82 (e.g., a first tip and a second tip) positioned opposite from each other (i.e., disposed 180 degrees from one another) relative to the handle axis HA. The grip sleeve portion 50 also has two notches 94a positioned opposite from each other (i.e., disposed 180 degrees from one another) relative to the handle axis HA. Other numbers and spacings the tips 82 and notches 94 are possible. The remaining notches 94b-94d may be similarly or otherwise spaced. The grip sleeve portion 50 includes a plurality of apertures 106 (see FIGS. 1, 6A, 6B) in communication with the notches 94. The apertures 106 may permit the user to view the position of the tips 82 from outside the grip sleeve portions 50.

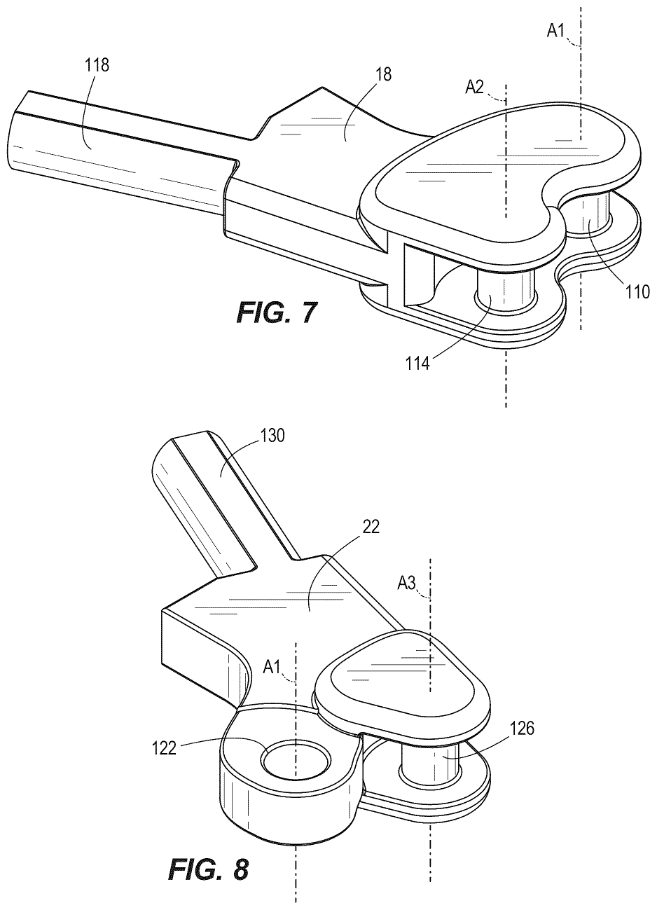

FIG. 7 illustrates the first link 18. The first link 18 is a one-piece structure which includes a first clevis pin 110 extending along the pivot axis A1 and a second clevis pin 114 extending along the first link axis A2. The first link 18 further includes a transmission portion 118 configured to transmit torque from the handle 34 to the blade 26.

FIG. 8 illustrates the second link 22. The second link 22 is a one-piece structure which includes a clevis hole 122 extending along the pivot axis A1 and a third clevis pin 126 extending along the second link axis A3. The second link 22 further includes a transmission portion 130 configured to transmit torque from the handle 38 to the blade 30.

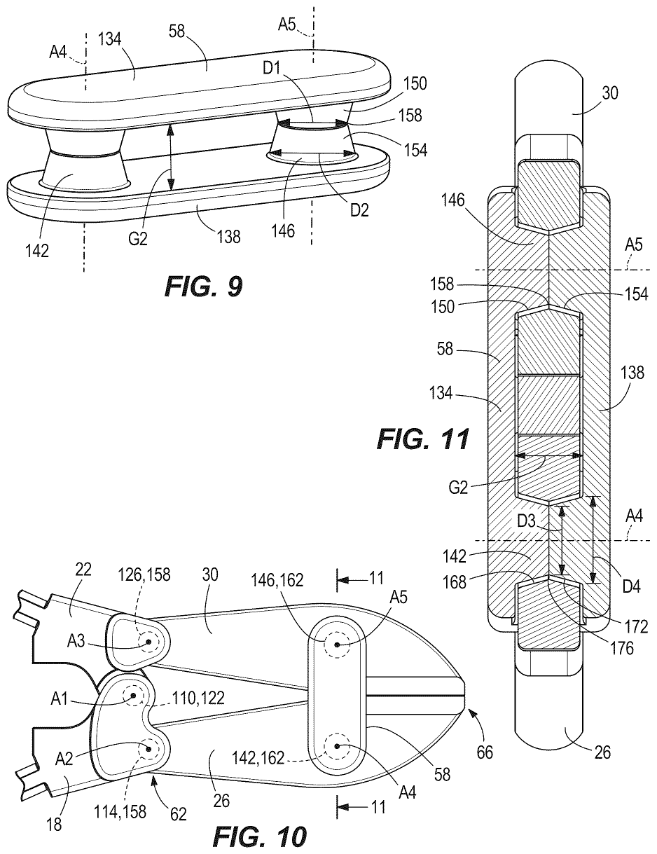

FIG. 9 illustrates the plate 58 in detail. The plate 58 includes two planar portions 134, 138 which are spaced from each other by a gap G2. In the illustrated embodiment, the gap G2 is generally parallel with the plate axes A4, A5. A pair of posts 142, 146 traverse the gap G2 to connect the two planar portions 134, 138 to one another. The gap G2 is dimensioned slightly larger than a thickness of the blades 26, 30 such that a portion of the blades 26, 30 may be positioned within the gap G2 and between the planar portions 134, 138.

Each of the posts 142, 146 is tapered and includes a first taper surface 150, a second taper surface 154, and a converging edge 158 between the first taper surface 150 and the second taper surface 154. In the illustrated embodiment, the converging edge 158 has a diameter D1 smaller than a diameter D2 of the opposite end of each taper surface 150, 154 directly adjacent the planar portions 134, 138. The illustrated taper surfaces 150, 154 are generally frustoconical in shape up to the converging edge 158. Otherwise shaped (e.g., non-linear) taper surfaces 150, 154 are possible.

FIG. 10 illustrates a top view of the cutting head 14. Each of the blades 26, 30 includes a blade hole 158 and a tapered aperture 162. The blade hole 158 is positioned adjacent the base portion 62 of the blades 26, 30. The tapered aperture 162 is positioned between the base portion 62 and the cutting portion 66 of the blades 26, 30.

The tapered apertures 162 are further illustrated in FIG. 11. Each tapered aperture 162 includes a first taper surface 168, a second taper surface 172, and a converging edge 176. In the illustrated embodiment, the converging edge 176 has a diameter D3 smaller than a diameter D4 of the opposite end of each taper surface 168, 172. The illustrated taper surfaces 168, 172 are generally annular and frustoconical in shape up to the converging edge 176. The taper surfaces 168, 172 generally match the geometry and dimensions of the taper surfaces 150, 154. However, otherwise shaped (e.g., non-linear) taper surfaces 168, 172 are possible.

In the cutting head 14, the first clevis pin 110 is received in the clevis hole 122 such that the first link 18 is intertwined with the second link 22. The blade holes 158 are aligned with the link axes A2, A3 and thus the second and third clevis pins 114, 126 such that the blades 26, 30 are intertwined with the links 18, 22. The tapered apertures 162 are aligned with the plate axes A4, A5 and thus the posts 142, 146 such that the blades 26, 30 are also intertwined with the plate 58. The blades 26, 30 are also sandwiched between the planar portions 134, 138 of the plate 58, the first link 18, and the second link 22. Accordingly, the first link 18 cannot be removed from the second link 22 by removing fasteners, etc. Rather, the components of the cutting head 14 are intertwined (i.e., interwoven) with one another. Such an intertwined relationship is created during the manufacture of the cutting head 14.

In the illustrated embodiment, the links 18, 22 and the plate 58 may be made via an additive manufacturing process. More specifically, the links 18, 22 and the plate 58 are made via a 3-Dimensional type printing process. Other additive manufacturing processes may be used to generate the above-described cutting head 14 having intertwined components. The blades 26, 30 may be made via the same 3-Dimensional type printing process or another manufacturing process. During construction of the cutting head 14, the blades 26, 30 are formed, and the links 18, 22, as well as the plate 58 are printed-in-place (PIP) relative to the blades 26, 30. In other words, the links 18, 22, and the plate 58 are printed-in-place with the blades 26, 30. Printing in place includes positioning the blades 26, 30 and forming the links 18, 22 and the plate 58 relative to the blades 26, 30 with the above-described intertwined nature of the links 18, 22, blades 26, 30, and the plate 58.

Various materials may be used to form the links 18, 22, blades 26, 30, and the plate 58. The links 18, 22, and the plate 58 may be made from fiberglass, carbon fiber reinforced nylon, or acrylonitrile butadiene styrene, or other similar materials. The blades 26, 30 may be made from 17-4PH stainless steel, H13 tool steel, or other similar steels or high-hardness materials. PLA plastic, Onyx, and 316L stainless steel and the like may also be used.

Depending on material selection of each component of the bolt cutter 10, post-processing including heat treating or the like may be required to increase the strength and toughness of the components. For example, the blades 26, 30 may be heat treated with a H900 treatment process to increase yield strength thereof, or a H1150 treatment process to increase ductility and toughness thereof. Other heat treating and post-processing may be applicable to the blades 26, 30 and/or other components of the bolt cutter 10.

The above-described bolt cutter 10 permits a user to adjust the length of the handles 34, 38. Accordingly, the user can adjust a mechanical advantage of the bolt cutter 10 depending on the size and hardness of a workpiece, and/or storage and use cases of the bolt cutter 10.

Due to the additive manufacturing process selected during construction of the bolt cutter 10, the above-described cutting head 14 includes a relatively small number of components when compared to traditional bolt cutting heads which require a plurality of fasteners. Accordingly, complexity of the bolt cutter 10 is reduced, and manufacturing of the bolt cutter 10 can be simplified, leading to cost and weight savings.

The tapered surfaces 150, 154, 168, 172 of the posts 142, 146 and the tapered apertures 162 of the blades 26, 30 inhibit misalignment of the blades 26, 30 relative to one another while moving the bolt cutter 10 between the closed position (FIG. 1) and the open position (FIG. 2). In other words, the apertures 162 circumscribe the posts 142, 146 such that the blades 26, 30 are movable between the open position (FIG. 2) and the closed position (FIG. 1) while inhibiting misalignment of the blades 26, 30. More specifically, the blades 26, 30 may be aligned both parallel to one another (i.e., not angled relative to the longitudinal axis) and opposed from each other in a co-planar relationship (i.e., not in differing intersecting planes).

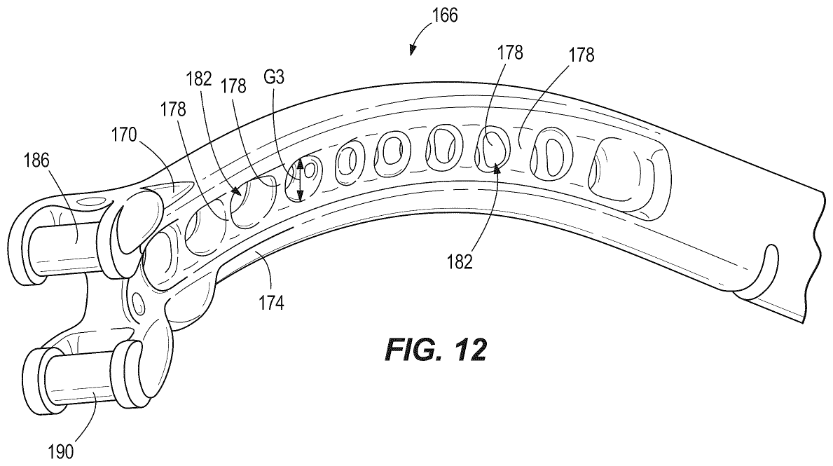

FIG. 12 illustrates an alternate handle 166. The alternate handle 166 includes a first bifurcated branch 170 and a second bifurcated branch 174 which oppose each other. A plurality of connecting columns 178 traverse a gap G3 between the branches 170, 174. The columns 178 may be sloped and include concave and convex portions. Between adjacent columns 178, variously shaped voids 182 are provided. The voids 182 generally reduce the weight of the alternate handle 166 when compared to the handles 34, 38 which include generally cylindrical handle portions 46. The alternate handle 166 may be dimensioned with an internal latticing and topology optimization software. The illustrated alternate handle 166 may be a one-piece component having a first clevis pin 186 and a second clevis pin 190 similar to the first link 18. The alternate handle 166 may be otherwise shaped to optimize the strength and weight of the alternate handle 166.

Although the invention has been described in detail with reference to certain preferred embodiments, variations and modifications exist within the scope and spirit of one or more independent aspects of the disclosure as described.

Various features of the disclosure are set forth in the following claims.

What is claimed is:

1. A bolt cutter comprising:
a first blade having a first tapered aperture;
a second blade having a second tapered aperture;
a first link pivotably coupled to the first blade;
a second link pivotably coupled to the first link and pivotably coupled to the second blade; and
a plate having a first planar portion, a second planar portion spaced from the first planar portion by a gap, a first tapered post traversing the gap, and a second tapered post traversing the gap,
wherein the first tapered aperture receives the first tapered post and the second tapered aperture receives the second tapered post such that the first blade and the second blade are movable between an open position and a closed position while inhibiting misalignment of the first blade and the second blade.

2. The bolt cutter of claim 1, wherein the first tapered post has a first taper surface, a second taper surface, and a converging edge between the first taper surface and the second taper surface.

3. The bolt cutter of claim 2, wherein the converging edge has a diameter smaller than a maximum diameter of the first taper surface and a maximum diameter of the second taper surface.

4. The bolt cutter of claim 2, wherein the first taper surface and the second taper surface are each generally frustoconical in shape to the converging edge.

5. The bolt cutter of claim 2, wherein at least one of the first taper surface and the second taper surface is linear.

6. The bolt cutter of claim 2, wherein at least one of the first taper surface and the second taper surface is non-linear.

7. The bolt cutter of claim 1, wherein the first tapered post and the second tapered post are the same shape.

8. The bolt cutter of claim 1, wherein the first tapered aperture includes a first taper surface, a second taper surface, and a converging edge.

9. The bolt cutter of claim 4, wherein the converging edge has a diameter smaller than a maximum diameter of the first taper surface and a maximum diameter of the second taper surface.

10. The bolt cutter of claim 1, wherein the plate is integrally formed as one-piece.

11. The bolt cutter of claim 1, wherein the first blade and the second blade are each integrally formed as one-piece and intertwined with the plate by the first link and the second link.

12. The bolt cutter of claim 11, wherein the plate, the first blade, and the second blade are made via an additive manufacturing process.

13. The bolt cutter of claim 1, wherein the first link, the second link, and the plate are made from a material selected from the group consisting of fiberglass, carbon fiber reinforced nylon, and acrylonitrile butadiene styrene.

14. The bolt cutter of claim 1, wherein the first tapered aperture, the first tapered post, the second tapered aperture, and the second tapered post inhibit misalignment of the first blade and the second blade from being oriented in intersecting planes.

15. The bolt cutter of claim 1, wherein the first tapered aperture, the first tapered post, the second tapered aperture, and the second tapered post promote a coincident parallel arrangement of the first blade and the second blade in a co-planar relationship.

16. The bolt cutter of claim 1, wherein the first blade and the second blade are movable between a closed position and an open position, and wherein the first tapered aperture, the first tapered post, the second tapered aperture, and the second tapered post promote a zero-clearance gap between the first blade and the second blade in the closed position.

17. The bolt cutter of claim 1, further comprising:
a first handle coupled to the first link, the first handle including a first handle portion and a first grip sleeve that is movable along the first handle portion to adjust a length of the first handle; and
a second handle coupled to the second link, the second handle including a second handle portion and a second grip sleeve that is movable along the second handle portion to adjust a length of the second handle.

18. The bolt cutter of claim 17, wherein each of the first and second handles includes a first branch, a second branch, and a plurality of connecting columns traversing a gap between the branches.
